(19) United States
(12) Patent Application Publication
(10) Pub. No.: US 2008/0284572 A1
(43) Pub. Date: Nov. 20, 2008

(54) DATA CONTROL SYSTEM, CONTROL SERVER, DATA CONTROL METHOD, AND PROGRAM

(76) Inventors: Mitsuhiro KIMURA, Kanagawa (JP); Tomoharu Hikita, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/116,103

(22) Filed: May 6, 2008

(30) Foreign Application Priority Data
May 14, 2007 (JP) P2007-128436

(51) Int. Cl. H04Q 5/22

(52) U.S. Cl. 340/10.51

(57) ABSTRACT

There is provided a data control system that includes a control server and an information processing terminal equipped with a non-contact type IC chip. The information processing terminal includes an internal memory in the IC chip and an update request portion. The internal memory includes at least one service area that can store a service data item and a control information item and includes an index area that stores a link information item for accessing the service area The update request portion transmits an update request that specifies the link information item and service area to be updated, as well as a type of update processing. The control server includes a data update portion that responds to the update request, performing the specified type of update processing on the specified link information item and service area and causing the specified link information item and service area to be updated.

### CROSS REFERENCES TO RELATED APPLICATIONS

The present invention contains subject matter related to Japanese Patent Application JP 2007-128436 filed in the Japan Patent Office on May 14, 2007, the entire contents of which being incorporated herein by reference.

### BACKGROUND OF THE INVENTION

1. Field of the Invention

The present invention relates to a data control system, a control server, a data control method, and a program.

2. Description of the Related Art

In recent years, information processing terminals have come into widespread use that are capable of non-contact communication with a reader/writer, such as mobile telephones and the like that are provided with non-contact type integrated circuit (IC) cards (hereinafter called by their generally used name “smart cards”) or non-contact type IC chips.

Being provided with an IC chip that is tamper-proof makes the information processing terminal that is capable of non-contact communication with the reader/writer, as described above, able to transmit, receive, and update securely data, such as electronic money and the like, for example, for which data falsification is a problem. Therefore, the providing of services that utilize the information processing terminal that is capable of non-contact communication with the reader/writer is spreading throughout society.

It is in this context that various technologies have been developed that utilize the information processing terminal that is provided with the IC chip and is capable of non-contact communication with the reader/writer. For example, a technology is disclosed in Japanese Patent Application Publication No. JP-A-2006-246015 that, by performing authentication of the information processing terminal in the same manner even if the information processing terminal is affiliated with a different carrier (a communication company or the like), makes communication possible between the reader/writer and the IC chip.

A memory in a known IC chip (see Japanese Patent Application Publication No. JP-A-2006-338423, for example) has one memory area (a service area Z) that has a hierarchical structure that contains at least one area (a service area A, B, or the like), as shown in FIG. 1. In this case, the area is the equivalent of a folder in the hierarchical structure. The reader/writer, by specifying an identification code that is assigned to each area (the service area A, B, or the like), for example, performs reading and writing of a data item (service data item a, b, or the like) that are stored in each area (the service area A, B, or the like) in the IC chip.

The known IC chip can have functions that perform consistent reading and writing of data items up to a fixed data size. Therefore, by setting the data size of the data items (service data items) that are stored in each area (service area) to no greater than the fixed data size, for example, the known IC chip makes the writing of the data items (service data items) reliable.

### SUMMARY OF THE INVENTION

However, as the providing of various services that utilize the information processing terminal that is equipped with the IC chip has become more widespread, a state has developed in which the data sizes of the data items (service data items) that are written to the memory within the IC chip are no longer limited to the fixed data size that the IC chip is capable of processing with consistency. In a case where the data size of the data item (service data item) that is written to the memory within the IC chip exceeds the fixed data size, the data item (service data item) must be divided into smaller units that must be written over the course of a plurality of cycles. However, because the consistency of the data items (service data items) that are written is not guaranteed, cases occur in which an improper state is created because the write processing fails before it is completed, such that an incomplete data item (service data item) is stored in the memory in the IC chip.

Further, the configuration of the memory in the IC chip is not limited to being one memory area that has a hierarchical structure that contains at least one area.

The present invention addresses the problem described above and provides a data control system, a control server, a data control method, and a program that are new and improved and that are capable of maintaining the consistency between memory areas in an IC chip that has two memory areas that are linked to one another and that is capable of non-contact communication with the reader/writer.

According to an embodiment of the present invention, there is provided a data control system that includes an information processing terminal and a control server. The information processing terminal is equipped with an IC chip that is capable of non-contact communication with a reader/writer, and the control server is capable of communication with the information processing terminal. The information processing terminal includes an internal memory that is provided within the IC chip. The internal memory includes at least one service area that is capable of storing a service data item that corresponds to a service that is provided through the reader/writer and storing a control information item for determining whether or not an update of the service data item has been completed. The internal memory also includes an index area that is capable of storing a link information item for each of the at least one service area for the purpose of accessing the service area. The information processing terminal also includes an update request portion that transmits to the control server an update request to start an update of the link information item and the service area that are specified by the update request, with a type of update processing also being specified by the update request. The control server includes a data update portion that, in response to the update request from the information processing terminal, performs the type of update processing that is specified by the update request on the link information item and the service area that are specified by the update request. The data update portion thus causes the link information item and the service area that are specified by the update request to be updated.

The information processing terminal that is a configuring element of the data control system and is equipped with the IC chip can include the internal memory that is provided in the IC chip and can also include the update request portion. The internal memory includes the at least one service area and the index area, for example. Each of the at least one service area can store the service data item that corresponds to the service that is provided through the reader/writer and can store a control information item for determining whether or not the update of the service data item has been completed. The index area can store the link information item for each of the at least one service area for the purpose of accessing the service area. The update request portion can transmit to the control server the update request to start the update of the link information item and the service area, with the type of update processing also being specified by the update request.

The control server that is a configuring element of the data control system can include the data update portion. In response to the update request that is transmitted from the information processing terminal, the data update portion can perform the type of update processing that is specified by the update request on the link information item and the service area that are specified by the update request. The data update portion can thus cause the link information item and the service area that are specified by the update request to be updated.

This configuration makes it possible to achieve a data control system that is capable of maintaining the consistency between the memory areas in the IC chip that has the two memory areas that are linked to one another and that is capable of non-contact communication with the reader/writer.

According to the embodiments of the present invention described above, there is provided a control server that is capable of communication with an information processing terminal that includes an internal memory within an IC chip that is capable of non-contact communication with a reader/writer. The internal memory includes at least one service area that is capable of storing a service data item that corresponds to a service that is provided through the reader/writer and storing a control information item for determining whether or not an update of the service data item has been completed. The internal memory also includes an index area that stores a link information item for each of the at least one service area for the purpose of accessing the service area. The information processing terminal is capable of transmitting an update request to start an update of the link information item and the service area that are specified by the update request, with a type of update processing also being specified by the update request. The control server includes a data update portion that, in response to the update request from the information processing terminal, performs the type of update processing that is specified by the update request on the link information item and the service area that are specified by the update request. The data update portion thus causes the link information item and the service area that are specified by the update request to be updated.

The control server can communicate with the information processing terminal that is equipped with the IC chip that is capable of non-contact communication with the reader/writer. The information processing terminal can include the internal memory within the IC chip that is capable of non-contact communication with the reader/writer. The internal memory can include the at least one service area that is capable of storing the service data item that corresponds to the service that is provided through the reader/writer and storing the control information item for determining whether or not the update of the service data item has been completed. The internal memory can also include the index area that stores the link information item for each of the at least one service area for the purpose of accessing the service area. The information processing terminal can transmit the update request to start the update of the link information item and the service area that are specified by the update request, with the type of update processing also being specified by the update request.

In addition, the control server can include the data update portion. In response to the update request that is transmitted from the information processing terminal, the data update portion can perform the type of update processing that is specified by the update request on the link information item and the service area that are specified by the update request. The data update portion can thus cause the link information item and the service area that are specified by the update request to be updated.

This configuration makes it possible for the control server, in response to the update request from the information processing terminal, to maintain the consistency between the memory areas in the IC chip that has the two memory areas that are linked to one another and that is capable of non-contact communication with the reader/writer.

The control server may also include a reading portion and a state determination portion. The reading portion may read from the internal memory of the information processing terminal the link information item and the service area that are specified by the update request. The state determination portion, based on at least one of the link information item and/or the service area that were read by the reading portion, may determine whether or not a transaction involved in the update processing has been completed. In a case where the update request specifies one of a registration processing that generates the service area or an update processing that updates the service area, and where it has been determined by the state determination portion that the transaction has been completed, the data update portion may terminate the type of update processing that is specified by the update request.

This configuration makes it possible for the control server, in response to the update request from the information processing terminal, to maintain the consistency between the memory areas in the IC chip that has the two memory areas that are linked to one another and that is capable of non-contact communication with the reader/writer.

In a case where the update request specifies the registration processing, the data update portion may cause the service area that is specified by the update request to be generated. The data update portion may also cause the service data item to be written. When the writing of the service data item is completed, the data update portion may cause the link information item that is specified by the update request to be updated with information for accessing the service area that is specified by the update request. The data update portion may also cause the control information item that indicates that the updating of the service data item has been completed to be written to the service area that is specified by the update request.

This configuration makes it possible for the control server to restore the consistency between the memory areas in the IC chip that is capable of non-contact communication.

It is desirable for the data update portion to cause the writing or the updating of the link information item and of the control information item to be performed in a synchronized manner.

In this case, the writing of a information item means both the generation of a new information item and the updating of an existing information item. For example, in a case where the control information item does not exist in the service area that is specified by the update request, the data update portion can generate the control information item. In a case where the control information item already exists in the service area that is specified by the update request, the data update portion can update the control information item. This configuration makes it possible to prevent an inconsistency from arising between the index area and the service area due to the update processing by the data update portion.

In a case where the update request specifies the update processing, the data update portion may cause the link information item that is specified by the update request to be updated with information that does not indicate an access destination. The data update portion may also cause the control information item that indicates that the updating of the service data item has not been completed to be written to the service area that is specified by the update request. The data update portion may also cause the service data item to be written to the service area. When the writing of the service data item is completed, the data update portion may cause the link information item that is specified by the update request to be updated with information for accessing the service area that is specified by the update request. The data update portion may also cause the control information item in the service area that is specified by the update request to be updated with information that indicates that the updating of the service data item has been completed.

This configuration makes it possible for the control server to restore the consistency between the memory areas in the IC chip that is capable of non-contact communication.

In a case where the update request specifies, as the type of update processing, a delete processing that deletes the service area, and where the link information item that was read by the reading portion contains information that does not specify an access destination for the service area, the data update portion may cause the service area that is specified by the update request to be deleted.

This configuration makes it possible for the control server to restore the consistency between the memory areas in the IC chip that is capable of non-contact communication.

In a case where the update request specifies, as the type of update processing, the delete processing that deletes the service area, and where the link information item that was read by the reading portion contains information that specifies an access destination for the service area, the data update portion may cause the link information item that is specified by the update request to be updated with information that does not indicate an access destination. The data update portion may also cause the control information item that indicates that the updating of the service data item has not been completed to be written to the service area that is specified by the update request.

This configuration makes it possible for the control server to restore the consistency between the memory areas in the IC chip that is capable of non-contact communication.

According to the embodiments of the present invention described above, there is provided data control method in a control server that is capable of communication with an information processing terminal that includes an internal memory within an IC chip that is capable of non-contact communication with a reader/writer. The internal memory includes at least one service area that is capable of storing a service data item that corresponds to a service that is provided through the reader/writer and storing a control information item for determining whether or not an update of the service data item has been completed. The internal memory also includes an index area that stores a link information item for each of the at least one service area for the purpose of accessing the service area. The information processing terminal is capable of transmitting an update request to start an update of the link information item and the service area that are specified by the update request, with a type of update processing also being specified by the update request. The data control method includes a step of acquiring the update request from the information processing terminal. The data control method also includes a step of performing, in response to the update request from the information processing terminal, the type of update processing that is specified by the update request on the link information item and the service area that are specified by the update request, thus causing the link information item and the service area that are specified by the update request to be updated.

Using this method makes it possible for the control server, in response to the update request from the information processing terminal, to maintain the consistency between the memory areas in the IC chip that has the two memory areas that are linked to one another and that is capable of non-contact communication with the reader/writer.

According to the embodiments of the present invention described above, there is provided a program in a control server that is capable of communication with an information processing terminal that includes an internal memory within an IC chip that is capable of non-contact communication with a reader/writer. The internal memory includes at least one service area that is capable of storing a service data item that corresponds to a service that is provided through the reader/writer and storing a control information item for determining whether or not an update of the service data item has been completed. The internal memory also includes an index area that stores a link information item for each of the at least one service area for the purpose of accessing the service area. The information processing terminal is capable of transmitting an update request to start an update of the link information item and the service area that are specified by the update request, with a type of update processing also being specified by the update request. The program includes a portion that acquires the update request from the information processing terminal. The program also includes a portion that performs, in response to the update request from the information processing terminal, the type of update processing that is specified by the update request on the link information item and the service area that are specified by the update request, thus causing the link information item and the service area that are specified by the update request to be updated.

This program makes it possible for the control server, in response to the update request from the information processing terminal, to maintain the consistency between the memory areas in the IC chip that has the two memory areas that are linked to one another and that is capable of non-contact communication with the reader/writer.

According to the embodiments of the present invention described above, the consistency between the memory areas can be maintained in the IC chip that has the two memory areas that are linked to one another and that is capable of non-contact communication with the reader/writer.

### BRIEF DESCRIPTION OF THE DRAWINGS

FIG. 1 is an explanatory figure that shows an example of a configuration of a memory area in a known IC chip;

FIG. 2 is an explanatory figure that shows an example of a configuration of memory areas in an IC chip according to embodiments of the present invention;

FIG. 3 is a block diagram that shows a data control system according to a first embodiment of the present invention;

FIG. 4 is an explanatory figure that shows an example of registration processing according to the embodiments of the present invention;

FIG. 5 is an explanatory figure that shows an example of update processing according to the embodiments of the present invention; and

FIG. 6 is an explanatory figure that shows an example of delete processing according to the embodiments of the present invention.

### DETAILED DESCRIPTION OF THE PREFERRED EMBODIMENTS

Hereinafter, preferred embodiments of the present invention will be described in detail with reference to the appended drawings. Note that, in this specification and the appended drawings, structural elements that have substantially the same function and structure are denoted with the same reference numerals, and repeated explanation of these structural elements is omitted.

Example of a Configuration of Memory Areas According to the Embodiments of the Present Invention

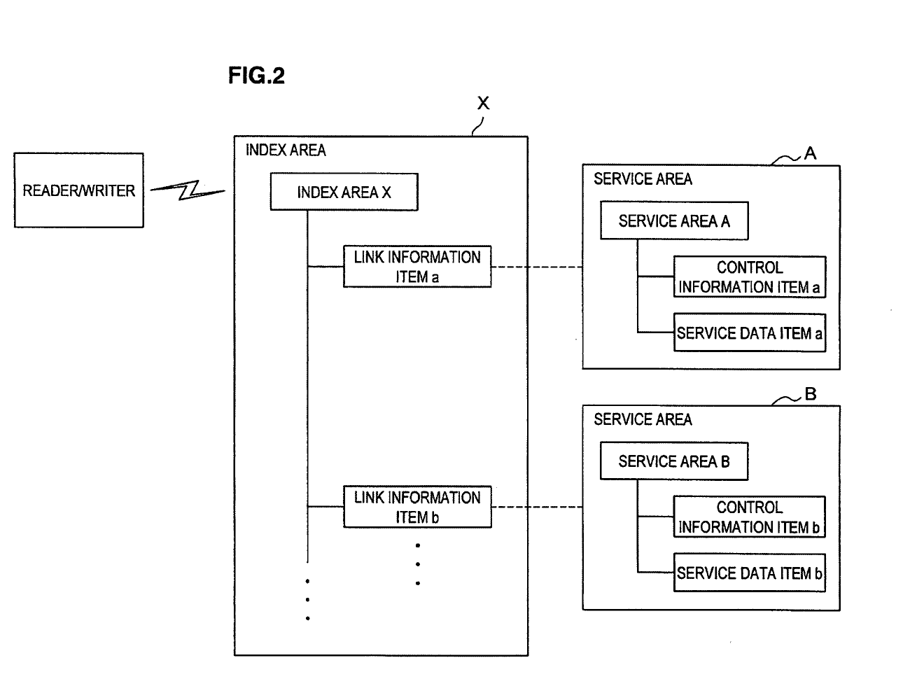

First, a configuration of memory areas in an IC chip according to the embodiments of the present invention will be explained. FIG. 2 is an explanatory figure that shows an example of the configuration of the memory areas in the IC chip according to embodiments of the present invention.

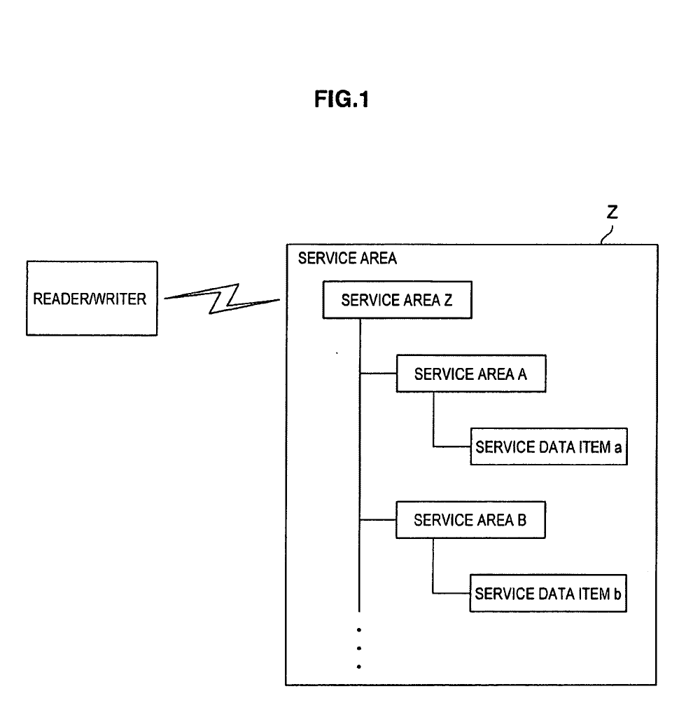

Referring to FIG. 2, the memory areas in the IC chip according to embodiments of the present invention include service areas A, B and an index area X to which the service areas A, B are individually linked. The service areas A, B can have hierarchical structures, in the same manner as a configuration of a known memory area shown in FIG. 1. In this case, an area is equivalent to a folder in the hierarchical structure. The service area A will be explained below as the service area, but the service area B is the same.

The service area A is an area in which is stored at least one of a data item for enabling a function of an information processing terminal and a data item (hereinafter called the “service data item”) for receiving a service using the IC chip, which is provided in the information processing terminal. The service area A is compatible with a variety of services. The service data item may be, for example, an electronic money value data item, a data item for personal authentication, a ticket data item, a data item that corresponds to a discount coupon, and the like, but the service data item is not limited to these examples.

The service area A can also store a control information item that indicates a state in which processing of the service data item that is stored in the service area A is in progress (that is, whether a transaction is in an uncompleted state) and a state in which the processing of the service data item is complete (that is, whether the transaction is in a completed state). The processing of the service data item may be processing that writes the service data item, for example, but it is not limited to this example. The control information item can be expressed by a single data bit that indicates whether or not the service data item is in a state of being processed, as shown by the two states (1) and (2) below.

(1) The control information item is “0”: The state in which the processing of the service data item is in progress.

(2) The control information item is “1”: The state in which the processing of the service data item has been completed.

Note that the control information item according to the embodiments of the present invention is not limited to being a single data bit and may also be a plurality of data bits that contain various types of information, such as identification information (that is, information that specifies the service data item) for specifying the content of the service, for example. Furthermore, an absence of the control information item from the service area can be defined as indicating that the processing of the service data item is in progress, but is not limited to this definition. In FIG. 2, a service data item a is stored in the service area A.

The index area X is an area that a reader/writer references in order to access each of the service areas. An information item (hereinafter called the “link information item”) that indicates a location of a service area for the purpose of accessing the service area is stored in the index area X for each of the service areas. The link information item may be an address or code that specifies the service area, an encryption key for accessing the service area, and the like, but the link information item is not limited to these examples. In FIG. 2, link information item a for accessing the service area A and link information item b for accessing the service area B are stored in the index area X.

The link information item can, for example, indicate the two states (3) and (4) shown below.

(3) Case in which the link information item indicates the address of the service area

(4) Case in which the link information item is a null value: State in which no service area is indicated (hereinafter called the “initialized state”)

Note that in (4) above, an example is given in which the link information item is the null value, but the value of the link information item that is set in the initialized state according to the embodiments of the present invention is obviously not limited to the null value.

For example, case (i) below can be said to be a state in which there is consistency does not exist between the service area A and the link information item a that is stored in the index area X (a state of inconsistency).

(i) Case where the service area A exists when the link information item a that is stored in the index area X is in the initialized state.

The state of inconsistency indicated by the case (i) above can occur in a case where the processing, for example, a transaction that updates the service area and the link information item that is stored in the index area X, was not completed properly (the processing terminated unexpectedly).

As shown in FIG. 2, the configuration of the memory areas within the IC chip according to the embodiments of the present invention, unlike the known configuration of the memory area shown in FIG. 1, includes at least two areas that are linked to one another, the at least two areas being the index area and the service area that corresponds to the index area. The embodiments of the present invention, in which the IC chip has the configuration of the memory areas that includes the at least two areas that are linked to one another, can maintain the consistency between the at least two areas by restoring a state of consistency, even in a case where the state of inconsistency described in case (i) above has occurred. Therefore, the reader/writer that reads the service data item from the IC chip according to the embodiments of the present invention can determine whether or not the service area that corresponds to the link information item a has been provided to the information processing terminal, by reading the link information item a that is stored in the index area X, for example.

Next, the embodiments of the present invention that make it possible to maintain the data consistency between the two areas that are linked to one another in the configuration of the memory areas in the IC chip according to the embodiments of the present invention will be explained.

### First Embodiment

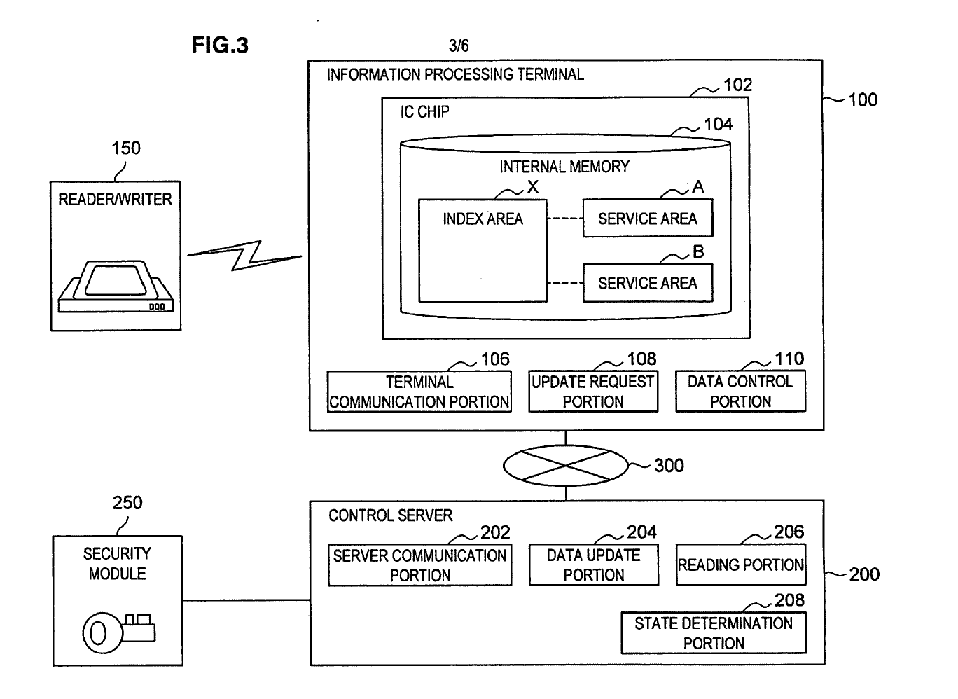

FIG. 3 is a block diagram that shows the data control system according to a first embodiment of the present invention.

Referring to FIG. 3, the data control system according to the first embodiment includes an information processing terminal 100, a reader/writer 150, a control server 200, and a security module 250. Note that in FIG. 3, only the information processing terminal 100 is shown as the information processing terminal, but the data control system according to the first embodiment may also include a plurality of information processing terminals. An example of data consistency between two areas that are linked to one another in an IC chip 102 (described later) that is provided in the information processing terminal 100 will be explained below.

The information processing terminal 100 and the reader/writer 150 can perform non-contact communication by using a magnetic field (a carrier wave) of a specific frequency, such as 13.56 MHz or the like, for example. By using the carrier wave, the reader/writer 150 can perform non-contact reading and writing of data in an IC chip 102 (described later) that is provided in the information processing terminal 100.

The information processing terminal 100 and the control server 200 are connected by a network circuit 300. The network circuit 300 may be, for example, a wired network such as a local area network (LAN), a wide area network (WAN), or the like, or a wireless network such as a wireless local area network (WLAN) or the like that uses multiple-input and multiple-output (MIMO). The network circuit 300 may also be the Internet and utilize a communications protocol such as the Transmission Control Protocol/Internet Protocol (TCP/IP). The network circuit 300 may also be a network that is connected via a base station or the like (not shown in the drawings) that fulfills the role of a wireless LAN access point, or a network that uses short range wireless communication that utilizes infrared light, IEEE 802.11 (called “Wi-Fi”), IEEE 802.15.1, or the like, for example. However, the network circuit 300 is not limited to these examples.

The Information Processing Terminal 100

The information processing terminal 100 can include the IC chip 102, a terminal communication portion 106, an update request portion 108, and a data control portion 110. The information processing terminal 100 may also include a terminal control portion (not shown in the drawings) that is configured from a micro processing unit (MPU) or the like and that controls the entire information processing terminal 100. The information processing terminal 100 may also include a terminal storage portion (not shown in the drawings) that stores data and an application that the information processing terminal 100 can execute, an operation portion (not shown in the drawings) that a user can operate, and the like. The terminal storage portion (not shown in the drawings) may be, for example, a memory such as a random access memory (RAM), a read only memory (ROM), or the like, or a magnetic storage medium such as a hard disk or the like, but it is not limited to these examples. The operation portion (not shown in the drawings) may be a button, a direction key, a rotary type selector such as a jog dial or the like, a combination of these, or the like, for example. The terminal control portion (not shown in the drawings) can also function as the update request portion 108 and the data control portion 110.

The IC chip 102 embodies in an integrated circuit various portions that are involved in communication with the reader/writer 150, and it can be tamper-proof. The IC chip 102 can include, for example, an internal memory 104 and an internal communication portion (not shown in the drawings).

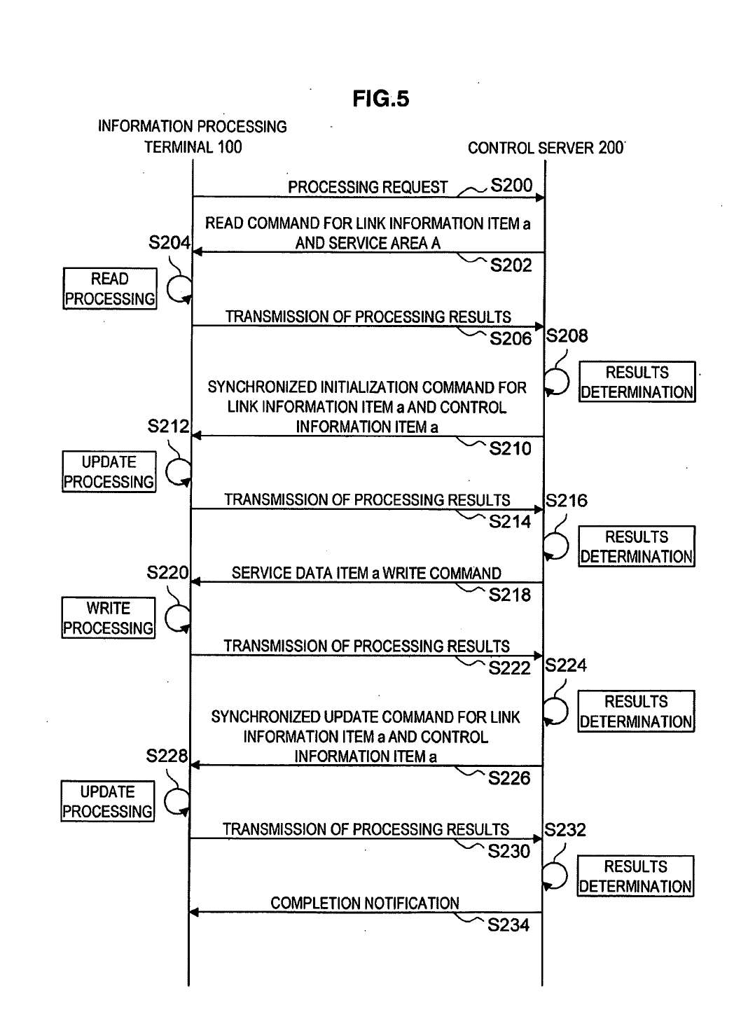

The internal memory 104 is a storage portion that is provided within the IC chip 102, and it can be tamper-proof. The internal memory 104 includes two areas that are linked to one another, the two areas being an index area and at least one service area that corresponds to the index area, like the index area and the service areas shown in FIG. 2. FIG. 5 shows the index area X and the service areas A, B as an example of the configuration of the internal memory 104.

The internal communication portion (not shown in the drawings) includes, for example, a coil that has a specified inductance and serves as a transmitting and receiving antenna and a resonance circuit that includes a capacitor that has a specified capacitance. The internal communication portion (not shown in the drawings) can receive the carrier wave that is transmitted from the reader/writer 150. By performing load modulation that varies the inductance of the information processing terminal 100 as seen from the reader/writer 150, the internal communication portion (not shown in the drawings) can perform communication with the reader/writer 150 through the carrier wave.

The terminal communication portion 106 is a portion for performing communication with an external device such as the control server 200 or the like through the network circuit 300. The terminal communication portion 106 can have a form and a function that match the type of the network circuit 300 (that is, the mode of the communication with the external device).

The update request portion 108 can generate an update request that requests a securement of the consistency between the index area and the least one service area. The update request portion 108 transmits the generated update request to the control server 200.

The update request that is generated by the update request portion 108 can contain, for example, information that indicates a location where a link information item is stored for which the consistency will be checked, as well as information that specifies the object of the consistency check, such as information that specifies the service area for which the consistency will be checked. The information that indicates the location where the link information item is stored and the information that specifies the object of the consistency check may be, for example, logical addresses in the index area and the service area.

The update request that is generated by the update request portion 108 can also contain, for example, information that specifies a type of update processing. The processing that is specified by the update request may be, for example, one of registration processing that creates the service area, update processing that updates the service area, and delete processing that deletes the service area. The registration processing, the update processing, and the delete processing according to the embodiments of the present invention will be described in detail later. The information that specifies the type of processing may be a predetermined processing number, for example. By interpreting the processing number, the control server 200 can perform the update processing of the type that is specified by the update request. A method by which the control server 200 interprets the processing number may be, for example, for the control server 200 to store and then use a table that correlates the processing number to the type of processing, but the method is not limited to this example.

The update request portion 108 can generate the update request based on a user input, for example. The user input may be, for example, a specified operation in which the user who uses the information processing terminal 100 uses the operation portion (not shown in the drawings). The user input may also be a generation command that is issued by an executable application in the information processing terminal 100. The update request portion 108 can also generate the update request in response to a generation command that is acquired from an external device outside the information processing terminal 100, for example.

The data control portion 110 is a portion that is capable of registering and deleting an area within the internal memory 104, as well as performing reading and writing of data. The data control portion 110 can also perform processing with respect to the internal memory 104 based on various commands from the control server 200 (described later).

The Control Server 200

The control server 200 can include a server communication portion 202, a data update portion 204, a reading portion 206, and a state determination portion 208. The control server 200 may also include a control portion (not shown in the drawings) that is configured from an MPU or the like and that controls the entire control server 200. The control server 200 may also include a control storage portion or the like (not shown in the drawings) that stores data and an application that the control server 200 can execute. The control storage portion (not shown in the drawings) may be, for example, a memory such as a RAM, a ROM, or the like, or a magnetic storage medium such as a hard disk or the like, but it is not limited to these examples. The control portion (not shown in the drawings) can also function as the data update portion 204, the reading portion 206, and the state determination portion 208.

The control server 200 can also include the security module 250, which stores an encryption key for accessing the internal memory 104 of the information processing terminal 100. In FIG. 3, the security module 250 is shown as a separate element from the control server 200, but it can also be provided within the control server 200. By using the encryption key that is stored in the security module 250 to access the internal memory 104 of the information processing terminal 100, the control server 200 can (directly and indirectly) access the internal memory 104 of the information processing terminal 100.

The server communication portion 202 is a portion for performing communication with an external device such as the information processing terminal 100 or the like through the network circuit 300. The server communication portion 202 has a form and a function that match the type of the network circuit 300 (that is, the mode of the communication with the external device).

When the data update portion 204 receives the update request from the information processing terminal 100, the data update portion 204 starts performing processing on the service area and the link information item that is stored in the index area, in the information processing terminal 100, that are specified by the update request. The data update portion 204 thus updates the link information item and the service area. When the updating is completed, the data update portion 204 can transmit to the information processing terminal 100 results information to the effect that the updating has been completed and that a state of consistency exists between the link information item and the service area. The data update portion 204 can then terminate the processing that is based on the update request.

In a case where the data update portion 204 performs the processing that is based on the update request, the reading portion 206 reads, from the internal memory 104 of the information processing terminal 100, the link information item and the service area that are specified by the update request. The procedure by which the reading portion 206 reads the link information item and the service area may be, for example, that the reading portion 206 transmits a read command to the information processing terminal 100 and that the data control portion 110 of the information processing terminal 100 reads the link information item and the service area based on the read command, then transmits the link information item and the service area to the control server 200. However, the procedure by which the reading portion 206 reads the link information item and the service area is not limited to this example.

The reading portion 206 can also transmit the read command to the security module 250 first, and the security module 250 can encrypt the read command and transmit it to the information processing terminal 100. By using an encryption key that is shared by the IC chip 102 of the information processing terminal 100, the security module 250 can perform encrypted communication, in which the communication between the control server 200 and the information processing terminal 100 is encrypted. Note that in the explanation that follows, the communication between the control server 200 and the information processing terminal 100 can be encrypted communication, although no particular mention of encrypted communication is made.

Based on a read result for the link information item and the service area that were read from the information processing terminal 100 by the reading portion 206, the state determination portion 208 determines whether or not processing was completed correctly in a previously performed transaction that updated the service area and the link information item that is stored in the index area X.

Data Control Method

Next, the registration processing, the update processing, and the delete processing according to the data control method according to the embodiments of the present invention will be explained. Note that in the explanation that follows, the objects of the consistency check are the service area A and the link information item a in the index area X in the information processing terminal 100. Further, the communication between the control server 200 and the information processing terminal 100 described below can be communication that is encrypted by the security module 250, but explanation of the encryption is omitted.

Registration Processing

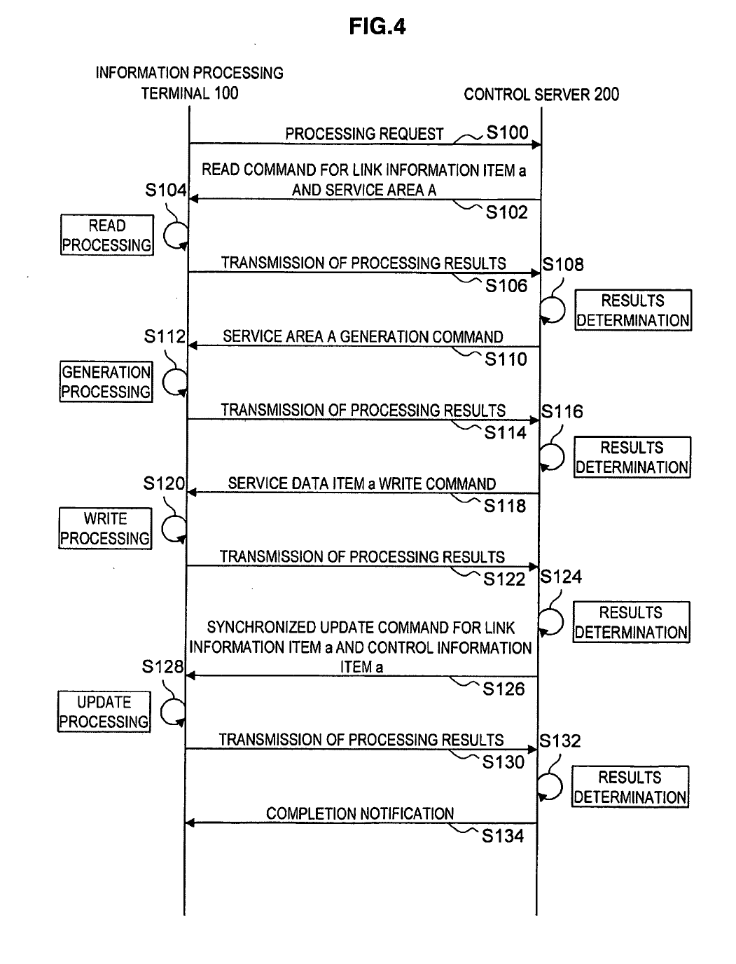

FIG. 4 is an explanatory figure that shows an example of the registration processing according to the embodiments of the present invention.

First, a processing request is transmitted from the information processing terminal 100 to the control server 200 (step S100). The processing request at step S100 may be an update request that includes, for example, information that specifies the link information item a and the service area A (for example, their addresses) that are the objects of the update, as well as information that specifies the registration processing (for example, the processing number that specifies the registration processing). The transmission of the update request at step S100 may be performed by an operation by the user who uses the information processing terminal 100, for example. It may also be performed based on an area generation (generation of a new area) command to the internal memory 104 in the IC chip 102 from another application that is stored in the information processing terminal 100.

The control server 200, having received the update request that was transmitted from the information processing terminal 100 at step S100, starts the registration processing in response to the update request. The control server 200 transmits to the information processing terminal 100 a read command to read, from the internal memory 104 in the information processing terminal 100, the service area A and the link information item a that is stored in the index area X (step S102).

The information processing terminal 100, having received the read command that was transmitted from the control server 200 at step S102, reads the link information item a and the service area A, based on the read command (step S104). The read processing at step S104 can be performed by the data control portion 110 of the information processing terminal 100, for example. The information processing terminal 100 then transmits to the control server 200 the link information item a and the service area A that were read at step S104 (step S106). At step S106, the information processing terminal 100 can transmit the service area A itself to the control server 200, and it can transmit to the control server 200 a service area read result that indicates whether or not the service area A could be read. In the same manner, at step S106, the information processing terminal 100 can transmit to the control server 200 the link information item a itself, and it can transmit to the control server 200 a link information item read result that indicates whether or not the link information item a has been initialized. Therefore, the information processing terminal 100 can perform the processing at step S106 even if the service area A was temporarily unreadable.

The link information item read result and the service area read result will be explained below as results that are transmitted from the information processing terminal 100.

The control server 200, having received the link information item a and the service area A that were transmitted from the information processing terminal 100 at step S106, determines whether or not the transaction has been completed (step S108).

In a case where the service area A could not be read, or in a case where the link information item a has been initialized, the control server 200 determines that the transaction has not been completed and continues the registration processing. In a case other than the two above, the control server 200 determines that the transaction has been completed. The control server 200 can then transmit to the information processing terminal 100 results information, for example, to the effect that the updating has been completed and that a state of consistency exists between the link information item and the service area. The control server 200 can then terminate the processing (the registration processing) that is based on the update request.

In a case where the control server 200 has determined at step S108 that the transaction has not been completed, the control server 200 transmits a service area A generation command to the information processing terminal 100 (step S110).

The information processing terminal 100, having received the service area A generation command at step S110, generates the service area A (step S112). The information processing terminal 100 then transmits a result of the generation processing at step S112 to the control server 200 (step S114). The generation processing at step S112 can be performed by the data control portion 110 of the information processing terminal 100, for example. In the explanation that follows, each step of the processing in the information processing terminal 100 is performed by the data control portion 110, although this is not explicitly stated. However, the configuring element that performs each step of the processing in the information processing terminal 100 is obviously not limited to the data control portion 110. The result of the generation processing can be, for example, a single data bit that indicates whether or not the service area A was generated (for example, “0” for a failed generation and “1” for a successful generation), but the result is not limited to this example.

The control server 200, having received the result of the generation processing that was transmitted at step S114, determines whether or not the service area A was generated, based on the result of the generation processing (step S116). In a case where it is determined at step S116 that the generation of the service area A failed, the control server 200 transmits error information to the information processing terminal 100 to the effect that the generation of the service area A failed, and terminates the processing that is based on the update request.

In a case where it is determined at step S116 that the generation of the service area A succeeded, the control server 200 transmits a write command to the information processing terminal 100, along with a service data item a that is to be stored in the generated service area A (step S118). The service data item a can be, for example, a data item that indicates an initial value for receiving a service, such as a data item that indicates “zero yen” as an electronic money value or the like. Note that the service data item a that is transmitted at step S118 is not limited to having the initial value. For example, the information processing terminal 100 can acquire the service data item a from a service provider device that provides a service and then transmit the acquired service data item a to the control server 200. At step S118, the control server 200 can then transmit the service data item a that has a value other than the initial value. The transmission of the service data item a from the information processing terminal 100 to the control server 200 can also be performed by, for example, performing the processing at steps S117A to S117C (not shown in the drawing) between step S116 and step S118, described below.

Step S117

(A) The control server 200 transmits a service data acquisition command to the information processing terminal 100.

(B) The information processing terminal 100, having received the service data acquisition command, acquires the service data item a from the service provider device.

(C) The information processing terminal 100 transmits to the control server 200 the service data item a it acquired from the service provider device.

The information processing terminal 100, having received the service data item a and the write command that were transmitted at step S118, writes the service data item a to the service area A (step S120). In a case where the data size of the service data item a is greater than a fixed data size that the IC chip 102 can write consistently, the information processing terminal 100 performs the writing of the service data item a over the course of a plurality of cycles. When the write processing is finished, the information processing terminal 100 transmits a result of the write processing to the control server 200 (step S122). The result of the write processing can be, for example, a single data bit that indicates whether or not the writing of the service data item a was completed correctly (for example, “0” for a failed write and “1” for a successful write), but the result is not limited to this example.

The control server 200, having received the result of the write processing that was transmitted at step S122, determines whether or not the service data item a was written correctly, based on result of the write processing (step S124). In a case where it is determined at step S124 that the service data item a was not written correctly, the control server 200 can perform the processing at step S118 once more, for example. The control server 200 may also transmit to the information processing terminal 100 error information to the effect that the processing that is based on the update request failed, and then terminate the processing that is based on the update request.

In a case where it is determined at step S124 that the service data item a was written correctly, the control server 200 transmits a synchronized update command to the information processing terminal 100 (step S126). The synchronized update command commands the information processing terminal 100 to perform, in a synchronized manner, an update of the link information item a in the index area X and a generation of a control information item a that indicates that the write processing for the service data item a to the service area A that was generated at step 110 has been completed. The update of the link information item a may be, for example, a writing of information that indicates a location of the service area A for the purpose of accessing the service area A.

By causing the update of the link information item a and the generation of the control information item a to be performed in a synchronized manner, the control server 200 can prevent the registration processing from giving rise to a new inconsistency between the service area A and the link information item a in the index area X.

The information processing terminal 100, having received the synchronized update command that was transmitted at step S126, performs synchronized update processing that performs the update of the link information item a in the index area X and the generation of the control information item a in the service area A in a synchronized manner (step S128). When the synchronized update processing is completed, the information processing terminal 100 transmits to the control server 200 a result of the synchronized update processing (step S130). The result of the synchronized update processing can be, for example, a single data bit that indicates whether or not the update of the link information item a and the generation of the control information item a were completed correctly (for example, “0” if either the update or the generation failed and “1” if both the update or the generation succeeded), but the result is not limited to this example.

The control server 200, having received the result of the synchronized update processing that was transmitted at step S130, determines, based on result of the synchronized update processing, whether or not the update of the link information item a in the index area X and the generation of the control information item a in the service area A were performed correctly (step S132). In a case where it is determined at step S132 that either the update of the link information item a or the generation of the control information item a in the service area A was not performed correctly, the control server 200 can perform the processing at step S126 once more, for example. The control server 200 may also transmit to the information processing terminal 100 error information to the effect that the processing that is based on the update request failed, and then terminate the processing that is based on the update request.

In a case where it is determined at step S132 that both the update of the link information item a in the index area X and the generation of the control information item a in the service area A were performed correctly, the control server 200 transmits to the information processing terminal 100 information to the effect that the updating has been completed and that a state of consistency exists between the link information item a and the service area A. The control server 200 then terminates the processing that is based on the update request (step S134).

Thus the registration processing according to the embodiments of the present invention, as shown in FIG. 4, generates the service area and writes the service data item. Then, when the writing of the service data item is completed correctly, the update of the link information item in the index area and the generation of the control information item that indicates that the write processing for the service data item has been completed are performed in a synchronized manner. Therefore, the control server 200 can perform the updating of the index area and the service area in the information processing terminal 100 that are specified by the update request, without destroying the consistency between the index area and the service area.

Furthermore, even if a state of inconsistency has come into being between the service area and the link information item that is stored in the index area, the registration processing according to the embodiments of the present invention can restore the state of consistency between the service area and the link information item that is stored in the index area.

Update Processing

Next, the update processing according to the embodiments of the present invention will be explained. FIG. 5 is an explanatory figure that shows an example of the update processing according to the embodiments of the present invention.

First, a processing request (an update request) is transmitted from the information processing terminal 100 to the control server 200 (step S200). The processing request at step S200 may be an update request that includes, for example, information that specifies the link information item a and the service area A (for example, their addresses) that are the objects of the update, as well as information that specifies the update processing (for example, the processing number that specifies the update processing).

The control server 200, having received the update request that was transmitted from the information processing terminal 100 at step S200, starts the update processing in response to the update request. In the same manner as in the registration processing shown in FIG. 4, the control server 200 transmits to the information processing terminal 100 a read command to read, from the internal memory 104 in the information processing terminal 100, the service area A and the link information item a that is stored in the index area X (step S202).

The information processing terminal 100, having received the read command that was transmitted from the control server 200 at step S202, reads the link information item a and the service area A, based on the read command (step S204). The information processing terminal 100 then transmits to the control server 200 the link information item a and the service area A that were read at step S204 (step S206).

The control server 200, having received the link information item a and the service area A that were transmitted from the information processing terminal 100 at step S206, determines whether or not the transaction has been completed (step S208).

In a case where, for example, the link information item a has been initialized, the control server 200 determines that the transaction has not been completed and continues the update processing. In any other case, the control server 200 determines that the transaction has been completed. The control server 200 can then transmit to the information processing terminal 100 results information, for example, to the effect that the updating has been completed and that a state of consistency exists between the link information item and the service area. The control server 200 can then terminate the processing (the update processing) that is based on the update request.

The control server 200 transmits a synchronized initialization command to the information processing terminal 100 (step S210). The synchronized initialization command commands the information processing terminal 100 to perform, in a synchronized manner, an initialization of the link information item a that is stored in the index area X (for example, a setting of the link information item a to the null value) and an initialization of the control information item a that is stored in the service area A (for example, a setting of the control information item a to “0”), such that the control information item a indicates that the processing of the service data item a is in progress. Performing the initialization of the link information item a and the initialization of the control information item a in a synchronized manner makes it possible to indicate to the reader/writer, to another application, to another process, and the like that the processing of the link information item a and the control information item a is in progress. Therefore, by causing the initialization of the link information item a and the initialization of the control information item a to be performed in a synchronized manner, the control server 200 can, for example, prevent a plurality of processes from being performed on the link information item a and the service area A while the update processing is in progress.

The information processing terminal 100, having received the synchronized initialization command that was transmitted at step S210, performs synchronized initialization processing that performs, in a synchronized manner, the initialization of the link information item a that is stored in the index area X and the initialization of the control information item a that is stored in the service area A (step S212). When the synchronized initialization processing is completed, the information processing terminal 100 transmits a result of the synchronized initialization processing to the control server 200 (step S214). The result of the synchronized initialization processing may be a single data bit that indicates whether or not the initialization of the link information item a and the initialization of the control information item a were completed correctly (for example, “0” for a failed initialization and “1” for a successful initialization), but the result is not limited to this example.

The control server 200, having received the result of the synchronized initialization processing that was transmitted at step S214, determines whether or not the initialization of the link information item a that is stored in the index area X and the initialization of the control information item a that is stored in the service area A were performed correctly, based on the result of the synchronized initialization processing (step S216). In a case where it is determined at step S216 that either the initialization of the link information item a or the initialization of the control information item a was not performed correctly, the control server 200 can perform the processing at step S210 once more, for example. The control server 200 may also transmit to the information processing terminal 100 error information to the effect that the processing that is based on the update request failed, and then terminate the processing that is based on the update request.

In a case where it is determined at step S216 that the initialization of the link information item a and the initialization of the control information item a were performed correctly, the control server 200, in the same manner as at step S118 in the registration processing shown in FIG. 4, transmits a write command to the information processing terminal 100, along with the service data item a that is to be stored in the service area A (step S218).

The information processing terminal 100, having received the service data item a and the write command that were transmitted at step S218, writes the service data item a to the service area A (step S220). At step S220, the information processing terminal 100 may overwrite the service data item a that is stored in the service area A with the service data item a that was transmitted at step S218. The information processing terminal 100 can also first delete the service data item a that is stored in the service area A, then write the service data item a that was transmitted at step S218. When the write processing is finished, the information processing terminal 100 transmits a result of the write processing to the control server 200 (step S222).

The control server 200, having received the result of the write processing that was transmitted at step S222, determines, in the same manner as at step S124 in the registration processing shown in FIG. 4, whether or not the service data item a was written correctly, based on the result of the write processing (step S224). In a case where it is determined at step S224 that the service data item a was not written correctly, the control server 200 can perform the processing at step S218 once more, for example. The control server 200 may also transmit to the information processing terminal 100 error information to the effect that the processing that is based on the update request failed, and then terminate the processing that is based on the update request.

In a case where it is determined at step S224 that the service data item a was written correctly, the control server 200 transmits a synchronized update command to the information processing terminal 100 (step S226). The synchronized update command commands the information processing terminal 100 to perform, in a synchronized manner, an update of the link information item a in the index area X and an update of the control information item a in the service area A, both of which were initialized at step 210.

The information processing terminal 100, having received the synchronized update command that was transmitted at step S226, performs synchronized update processing that performs the update of the link information item a in the index area X and the update of the control information item a in the service area A in a synchronized manner (step S228). When the synchronized update processing is completed, the information processing terminal 100 transmits to the control server 200 a result of the synchronized update processing (step S230).

The control server 200, having received the result of the synchronized update processing that was transmitted at step S230, determines, in the same manner as at step S132 in the registration processing shown in FIG. 4, whether or not the update of the link information item a in the index area X and the update of the control information item a in the service area A were performed correctly, based on result of the synchronized update processing (step S232). In a case where it is determined at step S232 that either the update of the link information item a in the index area X or the update of the control information item a in the service area A was not performed correctly, the control server 200 can perform the processing at step S226 once more, for example. The control server 200 may also transmit to the information processing terminal 100 error information to the effect that the processing that is based on the update request failed, and then terminate the processing that is based on the update request.

In a case where it is determined at step S232 that both the update of the link information item a in the index area X and the update of the control information item a in the service area A were performed correctly, the control server 200 transmits to the information processing terminal 100 information to the effect that the updating has been completed and that a state of consistency exists between the link information item a and the service area A. The control server 200 then terminates the processing that is based on the update request (step S234).

Thus the update processing according to the embodiments of the present invention, as shown in FIG. 5, first performs the initialization of the link information item in the index area and the initialization of the control information item in the service area in a synchronized manner. After the initializations, the update processing writes the service data item. When the writing of the service data item has been completed correctly, the update processing performs the update of the link information item in the index area and the update of the control information item in the service area in a synchronized manner. Therefore, the control server 200 can perform the updating of the index area and the service area in the information processing terminal 100 that are specified by the update request, without destroying the consistency between the index area and the service area.

Furthermore, even if a state of inconsistency has come into being between the service area and the link information item that is stored in the index area, the update processing according to the embodiments of the present invention can restore the state of consistency between the service area and the link information item that is stored in the index area.

Delete Processing

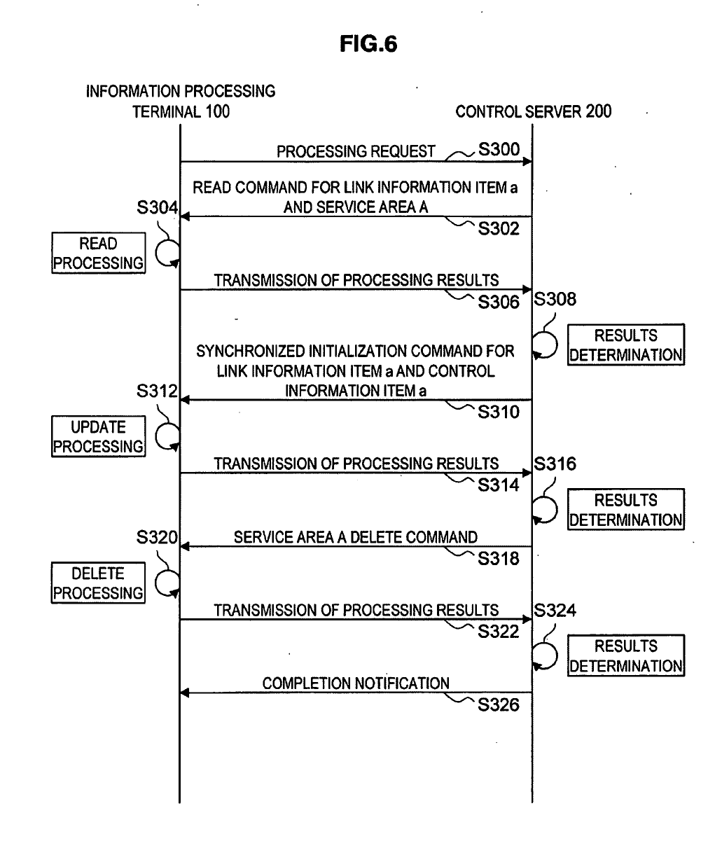

Next, the delete processing according to the embodiments of the present invention will be explained. FIG. 6 is an explanatory figure that shown an example of the delete processing according to the embodiments of the present invention.

First, a processing request (an update request) is transmitted from the information processing terminal 100 to the control server 200 (step S300). The processing request at step S300 may be an update request that includes, for example, information that specifies the link information item a and the service area A (for example, their addresses) that are the objects of the update, as well as information that specifies the delete processing (for example, the processing number that specifies the delete processing).

The control server 200, having received the update request that was transmitted from the information processing terminal 100 at step S300, starts the delete processing in response to the update request. In the same manner as in the registration processing shown in FIG. 4, the control server 200 transmits to the information processing terminal 100 a read command to read, from the internal memory 104 in the information processing terminal 100, the service area A and the link information item a that is stored in the index area X (step S302).

The information processing terminal 100, having received the read command that was transmitted from the control server 200 at step S302, reads the link information item a and the service area A, based on the read command (step S304). The information processing terminal 100 then transmits to the control server 200 the link information item a and the service area A that were read at step S304 (step S306).

The control server 200, having received the link information item a and the service area A that were transmitted from the information processing terminal 100 at step S306, determines whether or not the link information item a has been initialized (step S308).

In a case where, for example, it is determined that the link information item a has not been initialized, the control server 200 transmits to the information processing terminal 100 a command that is described below at step S310. In a case where, for example, it is determined that the link information item a has been initialized, the control server 200 transmits to the information processing terminal 100 a command that is described below at step S318 (that is, steps S310 to S316 in FIG. 6 are not performed). The delete processing will be explained in order, starting at step S310.

In a case where the control server 200 has determined at step S308 that the link information item a has not been initialized, the control server 200 transmits a synchronized initialization command to the information processing terminal 100 (step S310). The synchronized initialization command commands the information processing terminal 100 to perform, in a synchronized manner, the initialization of the link information item a that is stored in the index area X and the initialization of the control information item a that is stored in the service area A. By causing the initialization of the link information item a and the initialization of the control information item a to be performed in a synchronized manner, the control server 200 can, for example, prevent a plurality of processes from being performed on the link information item a and the service area A while the delete processing is in progress.

The information processing terminal 100, having received the synchronized initialization command that was transmitted at step S310, performs the synchronized initialization processing that performs, in a synchronized manner, the initialization of the link information item a that is stored in the index area X and the initialization of the control information item a that is stored in the service area A (step S312). When the synchronized initialization processing is completed, the information processing terminal 100 transmits a result of the synchronized initialization processing to the control server 200 (step S314).

The control server 200, having received the result of the synchronized initialization processing that was transmitted at step S314, determines whether or not the initialization of the link information item a that is stored in the index area X and the initialization of the control information item a that is stored in the service area A were performed correctly, based on the result of the synchronized initialization processing (step S316). In a case where it is determined at step S316 that either the initialization of the link information item a or the initialization of the control information item a was not performed correctly, the control server 200 can perform the processing at step S310 once more, for example. The control server 200 may also transmit to the information processing terminal 100 error information to the effect that the processing that is based on the update request failed, and then terminate the processing that is based on the update request.

In a case where it is determined at step S316 that the initialization of the link information item a and the initialization of the control information item a were performed correctly, as well as in a case where it is determined at step S308 that the link information item a has been initialized, the control server 200 transmits to the information processing terminal 100 a delete command for the service area A (step S318).

The information processing terminal 100, having received the delete command for the service area A that was transmitted at step S318, performs delete processing to delete the service area A (step S320). Then, when the delete processing is completed, the information processing terminal 100 transmits to the control server 200 a result of the delete processing (step S322). The result of the delete processing can be, for example, a single data bit that indicates whether or not the deletion of the service area A was completed (for example, “0” for a failed delete and “1” for a successful delete), but the result is not limited to this example.

The control server 200, having received the result of the delete processing that was transmitted at step S322, determines whether or not the deletion of the service area A was performed correctly, based on the result of the delete processing (step S324). In a case where it is determined at step S324 that the deletion of the service area A was not performed correctly, the control server 200 can perform the processing at step S318 once more, for example. The control server 200 may also transmit to the information processing terminal 100 error information to the effect that the processing that is based on the update request failed, and then terminate the processing that is based on the update request.

In a case where it is determined at step S324 that the deletion of the service area A was performed correctly, the control server 200 transmits to the information processing terminal 100 information to the effect that the updating has been completed and that a state of consistency exists between the link information item a and the service area A. The control server 200 then terminates the processing that is based on the update request (step S326).

Thus, in a case where the link information item has been initialized, the delete processing according to the embodiments of the present invention, as shown in FIG. 6, first performs the initialization of the link information item in the index area and the initialization of the control information item in the service area in a synchronized manner. After the initializations, the delete processing performs the deletion of the service area. When the deletion of the service area has been completed correctly, the processing that is based on the update request is terminated. Therefore, the control server 200 can perform the updating of the index area and the service area in the information processing terminal 100 that are specified by the update request, without destroying the consistency between the index area and the service area.

Furthermore, even if a state of inconsistency has come into being between the service area and the link information item that is stored in the index area, the delete processing according to the embodiments of the present invention can restore the state of consistency between the service area and the link information item that is stored in the index area.

The performing of the registration processing, the update processing, and the delete processing of the data control method according to the embodiments of the present invention, as shown in FIGS. 4 to 6, makes it possible for the control server 200 to perform the updating of the index area and the service area in the information processing terminal 100 that are specified by the update request, without destroying the consistency between the index area and the service area.

Furthermore, the performing of the registration processing, the update processing, and the delete processing of the data control method according to the embodiments of the present invention makes it possible for the control server 200 to restore the state of consistency between the service area and the link information item that is stored in the index area, even if a state of inconsistency has come into being between the service area and the link information item that is stored in the index area of the information processing terminal 100.

The registration processing, the update processing, and the delete processing of the data control method according to the embodiments of the present invention are not limited to being performed independently. For example, a plurality of types of processing can be performed in combination by specifying the plurality of types of processing in the update request, such as the delete processing followed by the registration processing, or the like. Therefore, by performing the registration processing, the update processing, and the delete processing independently or in combination, the control server 200 can restore the state of consistency between the service area and the link information item that is stored in the index area of the information processing terminal 100 that are specified by the update request that is transmitted from the information processing terminal 100.

As described above, in the data control system according to the embodiments of the present invention, the information processing terminal 100 can transmit the update request to the control server 200, and the control server 200, having received the update request, can update the service area and the link information item that is stored in the index area of the information processing terminal 100 that are specified by the update request, based on the type of processing that is specified by the update request. By performing the registration processing, the update processing, and the delete processing independently or in combination, based on the type of processing that is specified by the update request, the control server 200 can perform the updating of the index area and the service area in the information processing terminal 100 that are specified by the update request, without destroying the consistency between the index area and the service area.

Furthermore, the performing of the registration processing, the update processing, and the delete processing of the data control method according to the embodiments of the present invention makes it possible for the control server 200 to restore the state of consistency between the service area and the link information item that is stored in the index area, even if a state of inconsistency has come into being between the service area and the link information item that is stored in the index area of the information processing terminal 100.

Therefore, in the data control system according to the embodiments of the present invention, the consistency between the service area and the link information item that is stored in the index area of the information processing terminal 100 can be maintained by the control server 200.

Furthermore, the data control system according to the first embodiment of the present invention, mainly the control server 200, can control a transaction that involves the updating of the service area and the link information item that is stored in the index area of the information processing terminal 100. Therefore, no problems will occur as long as the information processing terminal 100 performs processing according to the commands from the control server 200, so the burden involved in the updating of the service area and the link information item that is stored in the index area of the information processing terminal 100 can be reduced. Moreover, the control server 200 according to the first embodiment of the present invention can control a transaction that involves the updating of the respective service areas and the link information items that are stored in the respective index areas of a plurality of information processing terminals. Therefore, the control server 200 can collectively control the consistency between each of the respective service areas and each of the corresponding link information items that are stored in each of the respective index areas of the plurality of information processing terminals.

The configuration of the internal memory within the IC chip according to the first embodiment of the present invention, unlike the known configuration of the memory area shown in FIG. 1, includes the at least two areas that are linked to one another, the at least two areas being the index area and the service area that corresponds to the index area. Therefore, the maintaining of the consistency between the service area and the link information item that is stored in the index area makes it possible for the reader/writer 150, by reading the link information item that is stored in the index area, to determine whether or not the service area that corresponds to the link information item has been provided in the information processing terminal 100.

First Use Example of the First Embodiment: Generation of an Area

In a case where the processing that is specified by the update request that the information processing terminal 100 transmits to the control server 200 is performed before processing is started to generate an area (register a new area), for example, the processing to generate the new area can be performed with a state of consistency in existence between the service area and the link information item that is stored in the index area of the information processing terminal 100.

Second Use Example of the First Embodiment: Configuration That Allows the User to Check the Consistency as Desired

The update request according to the first embodiment can be used to allow the user to check the consistency as desired by operating an operation portion (not shown in the drawings) that is provided in the information processing terminal 100.

In the explanation above, the information processing terminal 100 was used as an example of a configuring element in the configuration of the data control system according to the first embodiment of the present invention, but the first embodiment of the present invention is not limited to this example. A mobile communication device such as a mobile telephone or the like that is equipped with an IC chip can be used, as can a computer or the like, such as an ultra mobile personal computer (UMPC) or the like that is provided with an IC chip.

Also in the explanation above, the control server 200 was used as an example of a configuring element in the configuration of the data control system according to the first embodiment of the present invention, but the first embodiment of the present invention is not limited to this example. For example, a computer or the like, such as a personal computer, a server, or the like can be used.

Program According to the First Embodiment

A program that causes a computer to function as the control server 200 according to the first embodiment can restore the state of consistency and maintain the consistency between the service area and the link information item that is stored in the index area in the IC chip in the information processing terminal 100. The service area and the link information item between which the state of consistency is restored and maintained are the service area and the link information item that are specified by the update request that is transmitted from the information processing terminal 100 that is provided with the IC chip that includes the two areas that are linked to one another, that is, the index area and the service area.

### Second Embodiment

In the first embodiment described above, the configuration that was explained maintains the consistency between the service area and the link information item that is stored in the index area in the information processing terminal, with the control server playing the main role. However, the embodiments of the present invention are not limited to the configuration in which the control server plays the main role in maintaining the consistency between the service area and the link information item that is stored in the index area in the information processing terminal. For example, the information processing terminal itself can be the main element in maintaining the consistency between the service area and the link information item that is stored in the index area in the information processing terminal.

The information processing terminal according to the second embodiment can include a data update portion and a status update portion. The data update portion according to the second embodiment can perform an update in response to an update request, in the same manner as the data update portion 204 in the control server 200 according to the first embodiment.

The status update portion updates, as necessary, status information that indicates a status of processing in the data update portion according to the second embodiment, such as reading of the link information item or the service area, writing of a service data item, or the like. The status information may indicate what area is being processed, what processing is being done, and the like. The status information that is updated by the status update portion may be stored in a storage portion that is provided in the status update portion, and it can also be stored in a storage portion that is provided in the information processing terminal according to the second embodiment. The storage portion that is provided in the status update portion, and the storage portion that is provided in the information processing terminal may be, for example, magnetic storage media such as hard disks or the like, or non-volatile memories such as a flash memories or the like, or but they are not limited to these examples.

The data update portion according to the second embodiment can determine what processing is being performed, based on the status information that is updated as necessary by the status update portion. Accordingly, even in a case where the processing has failed before it is completed, for example, the data update portion according to the second embodiment, by referring to the status information, can determine the point up to which the processing has been completed and can perform the processing once again in order to restore consistency. Therefore, according to the second embodiment of the present invention, the information processing terminal itself can maintain the consistency between the service area and the link information item that is stored in the index area in the information processing terminal.

Program According to the Second Embodiment

A program that causes a computer to function as the information processing terminal according to the second embodiment can restore the state of consistency and maintain the consistency between the service area and the link information item that is stored in the index area in the information processing terminal that is provided with the IC chip that includes the two areas that are linked to one another, that is, the index area and the service area.

It should be understood by those skilled in the art that various modifications, combinations, sub-combinations and alterations may occur depending on design requirements and other factors insofar as they are within the scope of the appended claims or the equivalents thereof.

For example, in the registration processing, the update processing, and the delete processing according to the embodiments of the present invention, as shown in FIGS. 4 to 6, the processing is started by the transmission of the processing request from the information processing terminal 100, but the registration processing, the update processing, and the delete processing according to the present invention are not limited to this example. The various types of processing can also be started by having the control server transmit to the information processing terminal a command to start the processing, along with the type of processing. Even in this case, the control server according to the embodiments of the present invention can maintain the consistency between the service area and the link information item that is stored in the index area in the information processing terminal.

The configurations described above are illustrative examples of the embodiments of the present invention and are naturally within the technological scope of the present invention.

What is claimed is:

1. A data control system that comprises an information processing terminal and a control server, the information processing terminal being equipped with an IC chip that is capable of non-contact communication with a reader/writer and the control server being capable of communication with the information processing terminal,
wherein
the information processing terminal includes
an internal memory that is provided within the IC chip and that includes
at least one service area that is capable of storing a service data item that corresponds to a service that is provided through the reader/writer and storing a control information item for determining whether an update of the service data item has been completed,
an index area that is capable of storing a link information item for each of the at least one service area for the purpose of accessing the service area,
and
an update request portion that transmits to the control server an update request to start an update of the link information item and the service area that are specified by the update request, a type of update processing also being specified by the update request,
and
the control server includes
a data update portion that, in response to the update request from the information processing terminal, performs the type of update processing that is specified by the update request on the link information item and the service area that are specified by the update request, causing the link information item and the service area that are specified by the update request to be updated.

2. A control server that is capable of communication with an information processing terminal that includes an internal memory within an IC chip that is capable of non-contact communication with a reader/writer, the internal memory including at least one service area that is capable of storing a service data item that corresponds to a service that is provided through the reader/writer and storing a control information item for determining whether an update of the service data item has been completed and including an index area that stores a link information item for each of the at least one service area for the purpose of accessing the service area, the information processing terminal being capable of transmitting an update request to start an update of the link information item and the service area that are specified by the update request, a type of update processing also being specified by the update request, the control server comprising:
a data update portion that, in response to the update request from the information processing terminal, performs the type of update processing that is specified by the update request on the link information item and the service area that are specified by the update request, causing the link information item and the service area that are specified by the update request to be updated.

3. The control server according to claim 2, further comprising:
a reading portion that reads from the internal memory of the information processing terminal the link information item and the service area that are specified by the update request; and
a state determination portion that, based on at least one of the link information item and/or the service area that were read by the reading portion, determines whether a transaction involved in the update processing has been completed,
wherein the data update portion, in a case where the update request specifies one of a registration processing that generates the service area or an update processing that updates the service area, and where it has been determined by the state determination portion that the transaction has been completed, terminates the type of update processing that is specified by the update request.

4. The control server according to claim 3,
wherein
the data update portion, in a case where the update request specifies the registration processing, causes the service area that is specified by the update request to be generated and causes the service data item to be written, and
the data update portion, when the writing of the service data item is completed, causes the link information item that is specified by the update request to be updated with information for accessing the service area that is specified by the update request and causes the control information item that indicates that the updating of the service data item has been completed to be written to the service area that is specified by the update request.

5. The control server according to claim 4,
wherein the data update portion causes the writing or the updating of the link information item and of the control information item to be performed in a synchronized manner.

6. The control server according to claim 3,
wherein
the data update portion, in a case where the update request specifies the update processing, causes the link information item that is specified by the update request to be updated with information that does not indicate an access destination, causes the control information item that indicates that the updating of the service data item has not been completed to be written to the service area that is specified by the update request, and causes the service data item to be written to the service area, and
the data update portion, when the writing of the service data item is completed, causes the link information item that is specified by the update request to be updated with information for accessing the service area that is specified by the update request and causes the control information item in the service area that is specified by the update request to be updated with information that indicates that the updating of the service data item has been completed.

7. The control server according to claim 3,
wherein the data update portion, in a case where the update request specifies, as the type of update processing, a delete processing that deletes the service area, and where the link information item that was read by the reading portion contains information that does not specify an access destination for the service area, causes the service area that is specified by the update request to be deleted.

8. The control server according to claim 3,
wherein the data update portion,
in a case where the update request specifies, as the type of update processing, a delete processing that deletes the service area, and where the link information item that was read by the reading portion contains information that specifies an access destination for the service area,
causes the link information item that is specified by the update request to be updated with information that does not indicate an access destination and causes the control information item that indicates that the updating of the service data item has not been completed to be written to the service area that is specified by the update request.

9. A data control method for a control server that is capable of communication with an information processing terminal that includes an internal memory within an IC chip that is capable of non-contact communication with a reader/writer, the internal memory including at least one service area that is capable of storing a service data item that corresponds to a service that is provided through the reader/writer and storing a control information item for determining whether an update of the service data item has been completed and including an index area that stores a link information item for each of the at least one service area for the purpose of accessing the service area, the information processing terminal being capable of transmitting an update request to start an update of the link information item and the service area that are specified by the update request, a type of update processing also being specified by the update request, the data control method comprising the steps of:
acquiring the update request from the information processing terminal; and
performing, in response to the update request from the information processing terminal, the type of update processing that is specified by the update request on the link information item and the service area that are specified by the update request, thus causing the link information item and the service area that are specified by the update request to be updated.

10. A program for a control server that is capable of communication with an information processing terminal that includes an internal memory within an IC chip that is capable of non-contact communication with a reader/writer, the internal memory including at least one service area that is capable of storing a service data item that corresponds to a service that is provided through the reader/writer and storing a control information item for determining whether an update of the service data item has been completed and including an index area that stores a link information item for each of the at least one service area for the purpose of accessing the service area, the information processing terminal being capable of transmitting an update request to start an update of the link information item and the service area that are specified by the update request, a type of update processing also being specified by the update request, the program comprising instructions that command a computer to function as:
a portion that acquires the update request from the information processing terminal; and
a portion that performs, in response to the update request from the information processing terminal, the type of update processing that is specified by the update request on the link information item and the service area that are specified by the update request, thus causing the link information item and the service area that are specified by the update request to be updated.
